(19) United States
(12) Patent Application Publication
(10) Pub. No.: US 2009/0060373 A1
(43) Pub. Date: Mar. 5, 2009

(54) METHODS AND COMPUTER READABLE MEDIUM FOR DISPLAYING A RESTORED IMAGE

(75) Inventors: Ambalangoda Gurunnanselage Amitha Perera, Clifton Park, NY (US); Frederick Wilson Wheeler, Niskayuna, NY (US); Anthony James Hoogs, Niskayuna, NY (US); Benjamin Thomas Verschueren, Niskayuna, NY (US); Nils Oliver Krahnstoever, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/195,017

(22) Filed: Aug. 20, 2008

Related U.S. Application Data
(60) Provisional application No. 60/957,797, filed on Aug. 24, 2007.

(51) Int. Cl. G06K 9/40

(52) U.S. Cl. 382/264

(57) ABSTRACT

Methods and computer program readable medium for restoring an image. The methods include the steps of selecting one or more frames followed by determining the regions of interest so that blurring effect is determined in the regions of interest using various techniques. The regions of interest are then deblurred and one of the deblurred regions of interest is then blended with the frame resulting in a restored frame.

### CROSS REFERENCE TO RELATED APPLICATIONS

This application claims the benefit of U.S. Provisional Application No. 60/957,797 filed on Aug. 24, 2007, which is incorporated herein in its entirety by reference.

### BACKGROUND OF THE INVENTION

The present invention relates generally to methods and computer readable medium for displaying enhanced images.

In TV broadcasting, especially in sports broadcasting, it is often useful to focus on a particular point of the screen at a particular time. For example, commentators, fans or referees may wish to determine if a football player placed his foot out of bounds or not when catching the ball, or to determine if a tennis ball was in-bounds, and so on.

While techniques that enlarge a particular portion of a video frame are available, including estimation of motion blur and removing the same. One known technique for reducing the effects of motion blur involve analyzing consecutive frames and determining motion vectors for some portion of the frame. If the motion vector reaches a certain threshold that warrants processing, a scaling factor is processed and deblurring is performed using a deconvolution filter. However, there are many limitations with such approaches. For instance, a still frame, such as a “paused” video frame from the time of interest, has a number of characteristics that may prevent the image from being clear when enlarged, such as: insufficient resolution (based on the camera zoom level); motion blur (due to camera and/or player or ball motion); interlacing artifacts associated with the broadcast or recording; and other optical distortions including camera blur.

While techniques exist to compensate for such limitations, such as by applying de-interlacing algorithms or recording at a significantly higher resolution than necessary for broadcast purposes. These techniques often do not achieve the required level of improvement in the resulting enlarged image, and may incur significant overhead costs. For example, recording at a higher resolution imposes storage, bandwidth and camera quality requirements that can increase the expense of such a system significantly.

Therefore, there is a continued need for improved systems to extract the most useful picture information for the relevant portions of images taken from video, and to do so in a time-effective manner that allows the restored image to be used quickly.

### BRIEF DESCRIPTION

In accordance with one exemplary embodiment of the present invention a method of image restoration is shown. The steps comprise selecting at least one frame to be restored; selecting at least one region of interest in the frame; estimating motion within said region of interest; determining blur within said region of interest; performing deblurring of said region of interest; and generating a restored region of interest.

In accordance with another exemplary embodiment a method for restoring at least a portion of a frame is provided. The method comprise selecting said frame for restoration; deinterlacing to obtain at least one of a previous frame or a subsequent frame; establishing a region of interest in said frame; performing motion estimation to obtain at least one motion vector; deblurring said region using at least said motion vector and creating a deblurred region; and blending said deblurred region into said frame.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a flowchart for restoration of an image in accordance with one embodiment of this invention.

FIG. 2 shows the original image captured during a game by a video camera.

FIG. 3 shows an interlaced frame, which can be zoomed.

FIG. 4 shows a graphical user interface showing the selected frame wherein a user is asked to select region of interest.

FIG. 5 illustrates a region of interest selected that includes name of the player at the backside of his T-shirt.

FIG. 6 shows a graphical user interface with the selected region of interest frame of FIG. 5 in which the user is asked to select a point of interest.

FIG. 7 shows nine different deblurred and restored regions of interest selected by the user in FIG. 2.

FIG. 8 shows a restored frame with the restored region of interest blended with the frame.

FIG. 9 shows a system diagram with the elements used for restoring an image in accordance with one embodiment of this invention.

### DETAILED DESCRIPTION

The systems and techniques herein provide a method and system generating an image of certain sections of a frame that have higher quality than the unrestored frame, allowing the viewer to better judge the event in question. It should be noted that the words image and frame are used in the specification conveying a similar meaning and have been used interchangeably.

As discussed in detail herein, embodiments of the present invention provide for restoring images. The frames or images, for example, may be selected from any one of the frames of a video depending upon the requirements. Video input, which can include one or more video cameras or one or more still cameras set to automatically take a series of still photographs, obtain multiple frames of video (or still photographs), each to include an image. It should be appreciated that the video input may be live or still photographs. If the video or still photographs are analog-based, an analog-to-digital converter would be required prior to transmitting the frames. The output frames of the video input are transmitted to a display device, which device is used to identify the regions of interest in the image.

Various forms of image reconstruction are known in the art and a basic description is provided to aid in interpretation of certain features detailed herein. Image super-resolution, or multi-view image enhancement, refers in general to the problem of taking multiple images of a particular scene or object, and producing a single image that is superior to any of the observed images. Because of slight changes in pixel sampling, each observed image provides additional information. The super-resolved image offers an improvement over the resolution of the observations. Whatever the original resolution, the super-resolved images will be some percentage better. The resolution improvement is not simply from interpolation to a finer sampling grid, and there is a genuine increase in fine detail.

There are several reasons for the improvement that super-resolution yields. First, there is noise reduction, which comes whenever multiple measurements are averaged. Second, there is high-frequency enhancement from deconvolution similar to that achieved by Wiener filtering. Third, there is de-aliasing. With multiple observed images, it is possible to recover high resolution detail that could not be seen in any of the observed images because it was above the Nyquist bandwidth of those images.

Further details regarding image reconstruction can be found Frederick W. Wheeler and Anthony J. Hoogs, “Moving Vehicle Registration and Super-Resolution”, Proc. of IEEE Applied Imagery Pattern Recognition Workshop (AIPR07), Washington D.C., October, 2007.

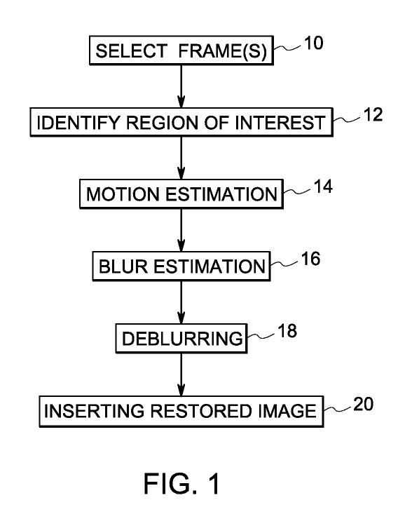

FIG. 1 illustrates a flowchart for restoration of an image in accordance with one embodiment. One or more frames to be restored are selected in step 10. The frames may be selected manually or may be a set of consecutive frames.

In one embodiment an interlaced frame selected from a video is split in two frames by being deinterlaced. Alternatively, two or more subsequent or consecutive frames or similar time sequenced frames of a video can be selected.

The selection of frames is followed by region of interest selection in step 12. The region of interest may be selected by a user manually, semi-automatically or automatically. The region of interest is typically a smaller portion of the entire frame that accommodates processing of the smaller portion and reduced computer resources.

The region of interest in one aspect occupies substantially all of the frame such the entire frame is the region of interest. Alternatively, the region of interest comprises one or more portions of the frame such that more than one region of interest in a frame is processed.

The region of interest in one example can depend upon the application of the image. For instance, in certain sports such as football it may be important to ascertain whether an object, such as the foot of player, is out of bounds at an important moment during the game, and the area about the object may represent the region of interest in a frame. Similarly, the number or name of a player at the back of his t-shirt may be a region of interest to a broadcaster. In car racing events the region of interest may be the tracking of certain features of the vehicle. It should be noted that there can be more than one region of interest in an image or frame and there may be more than a single object in each region of interest.

In one embodiment, a region of interest selection comprises manual selection by a user using a graphical user interface. The user would interface with the display of the frame and can use a mouse or similar interface to select the region of interest. The manual selection provides the operator with some control over the area of interest, especially if the area of interest is not pre-defined. The region of interest can be defined by any shape such as circular, oval, square, rectangular and polygonic. The size of the region of interest is typically selected to be sufficient to capture the image such that the region provides enough area around a particular point of interest as to provide sufficient context.

In another embodiment the program automatically or semi-automatically selects the region of interest. In one aspect the region of interest is somewhat pre-defined such as the goal posts in football or hockey such that there are known identifiable fixed structures that can be used to define the region of interest. The pre-defined region of interest in one aspect can be accommodated by camera telemetry that would provide a known view or it can be accomplished during the processing to automatically identify the region based upon certain known identifiable objects about the frame.

In another aspect the user may select a point of interest, and the system processing would create a region of interest about the point of interest.

The selection of the region of interest may be followed by the selection of a point of interest region within the region of interest. The point of interest selection can be a manual selection, automatic selection, or semi-automatic and may focus on an particular object of interest

In one example, a program selects a center point of the region of interest as a point of interest with a certain sized region about the point of interest and the restoration is performed on the point of interest. Alternatively, a user can select one or more points of interest within the region of interest. In another embodiment a user can manually select a point of interest within the region of interest. The size and shape of the point of interest region may be pre-determined by design criteria or be manually established. In a typical scenario, the point of interest region will be sufficiently sized to capture the object of interest and be less than the entire region of interest since processing larger sized areas.

One or more regions of interest can be selected by a user. In one aspect, the regions of interest are then extracted from the frames so that motion estimation may be performed for the region of interest. The motion estimation in one embodiment comprises estimating motion of an object of interest that can be further identified as the point of interest. In another embodiment the entire region of interest is subject to the motion estimation.

The region of interest identification is followed by motion estimation in step 14. The motion estimation may also include registration of multiple frames and is performed by applying various processes.

In one of the embodiments the motion estimation comprise use of as much of the domain knowledge available as possible to help in the image restoration. The domain knowledge can include: the camera motion; the player and object motion; the structure and layout of the playing area (for example, the football field, swimming pool, or tennis court); and any known models for the objects under consideration (e.g. balls, feet, shoes, bats). Some of this domain knowledge may be available a priori (e.g. the size and line markings of a football field), while others may be estimated from the video (e.g. the motion of the player), or generated or provided in real-time (such as the pan-tilt-zoom information for the camera that produced the image). The domain knowledge can be used in multiple ways to restore the image.

Information about the cameras is used for motion estimation and can include information about the construction and settings of the optical path and lenses, the frame rate of the camera, aperture and exposure settings, and specific details about the camera sensor (for example the known sensitivity of a CCD to different colors). Similarly, knowledge of “fixed” locations in the image (e.g. the lines on the field, or the edge of a swimming pool) can be used to perform better estimates of the camera motion and blur region of interest.

For camera systems that employ camera telemetry and computerized tracking systems, the camera tracking speed and views are processed parameters and can be used in the subsequent processing. Sensor information can also be utilized such as GPS sensors located in racing cars that can give location and speed information.

In one embodiment the motion estimation comprise pixel-to-pixel motion of the region of interest or the point of interest. The motion estimation results in motion vector V that denotes the velocity of pixels or the motion of pixels from one frame to another.

The determination of the motion estimation vector can be followed by determining n variations of the motion estimation vector. The determination of n variations of the motion estimation vector can result in selection of best-restored image at the end. In an exemplary embodiment, nine variations of the motion estimation can comprise of V, V+[0,1], V+[0,−1], V+[1,0], V+[1,1], V+[1,−1], V+[−1,0], V+[−1,1], V+[−1,−1] where V is a vector whose X and Y components denote a velocity in the image and the added terms denote X and Y offsets to the velocity vector. The determination of number and magnitude of variations of motion vector to be determined depends upon the quality of image required. More is the number of variation of motion estimation vector more is the number of restored region of interest and thus more options for selection of restored regions of interest.

The motion estimation or registration is followed by determination of blur 16 in the frame.

The motion estimation is followed by blur estimation in step 16, wherein the blur estimation is performed in accordance with the various techniques illustrated herein. In an example the blur can comprise optical blur and/or object blur. In one of the embodiments the motion estimation uses domain knowledge to help in the image restoration. The domain information may include, for example, blur effect information introduced due to camera optics, motion of an object, the structure and layout of the playing area. Knowledge of the camera, such as its optics, frame rate, aperture, exposure time, and the details of its sensor (CCD), and subsequent processing also aids in processing blur effect.

With respect to the motion blur estimation from domain knowledge, broadcast-quality video cameras have the ability to accurately measure their own camera state information and can transmit the camera state information electronically to other devices. Camera state information can include the pan angle, tilt angle and zoom setting. Such state information is used for field-overlay special effects, such as the virtual first down line shown in football games. These cameras can be controlled by a skilled operator, although they can also be automated/semi-automated and multiple cameras can be communicatively coupled to a central location.

According to one embodiment, the motion blur kernel for objects in a video can be determined from the camera state information or in combination with motion vector information. Given the pan angle rate of change, the tilt angle rate of change, the zoom setting and the frame exposure time, the effective motion blur kernel can be determined for any particular location in the video frame, particularly for stationary objects. This blur kernel can then be used by the image restoration process to reduce the amount of blur.

With respect to the optical blur from domain knowledge, the optical blur introduced by a video camera may be determined through analysis of its optical components or through a calibration procedure. Optical blur is generally dependent on focus accuracy and may also be called defocus blur. Even with the best possible focus accuracy, all cameras still introduce some degree of optical blur. The camera focus accuracy can sometimes be ignored, effectively making the reasonable assumption that the camera is well-focused, and the optical blur is at its minimum, though still present.

If the optical blur of a camera is known, it can be represented in the form of an optical blur kernel. In one embodiment, the motion blur kernel and the optical blur kernel may be combined through convolution to produce a joint optical/motion blur kernel. The joint optical/motion blur kernel may be used by the image restoration process to reduce the amount of blur, including both motion blur and optical blur.

The estimation of blur is followed by deblurring in step 18. In one aspect, the deblurring of the region of interest is performed by using at least one of the algorithms comprising Wiener filtering, morphological filtering, wavelet denoising and linear and non-linear image reconstruction with or without regularization. The deblurring in one aspect comprises deblurring one or more regions of interest of the frame resulting in one or more deblurred regions of interest. The deblurring can also be preformed on one or more objects or points of interest in the region of interest in at least one deblurred object. Furthermore the deblurring can be preformed for both the motion blur and optical blur.

In an embodiment deblurring technique can include Fast Fourier Transform (FFT) computation of the region of interest followed by computation of the FFT of linear region of interest induced by velocity V. Then an inverse Wiener filtering is performed in the frequency space followed by computation of inverse FFT of result to obtain deblurred region of interest. Alternatively, one or more techniques may be used for deblurring the region of interest.

In another embodiment the deblurring can be done by removing the camera blur and motion blur, for example by Wiener filtering. For multiple regions of interests of an image multiple blurring effects can be estimated. In a further aspect, the optical blur can be measured to determine if the subsequent processing is required. If the optical blur level is under the threshold level, it can be ignored.

A frame or a region of interest or the average of several frames or regions can be represented in the spatial frequency domain. If the transform original image is Iᵢ(ω₁, ω₂), the Optical Transfer Function (OTF, the Fourier Transform of the Point Spread Function (PSF)), which is blurred region of interest is H(ω₁, ω₂) and the additive Gaussian noise signal is N(ω₁, ω₂), then the observed video frame is:

G(ω₁,ω₂)=H(ω₁,ω₂)I(ω₁,ω₂)+N(ω₁,ω₂).

The Wiener filter is a classic method for single image deblurring. It provides a Minimum Mean Squared Error (MMSE) estimate of I(ω₁, ω₂). With a non-blurred image given a noisy blurred observation G(ω₁, ω₂), and with no assumption made about the unknown image signal, the Wiener filter 30 is:

I(ω₁,ω₂)=(H*(ω₁,ω₂))G(ω₁,ω₂)/|(H(ω₁,ω₂)|²+K).

The parameter H*(ω₁, ω₂) is the complex conjugate of H(ω₁, ω₂), and the parameter K is the noise-to-signal power ratio, thus forming the MMSE Wiener filter. In practice, the parameter K is adjusted to balance noise amplification and sharpening. If parameter K is too large, the image fails to have its high spatial frequencies restored to the fullest extent possible. If parameter K is too small, the restored image is corrupted by amplified high spatial frequency noise. As K tends toward zero, and assuming H(ω₁, ω₂)>0, the Wiener filter approaches an ideal inverse filter, which greatly amplifies high-frequency noise:

I(ω₁,ω₂)=G(ω₁,ω₂)/(H(ω₁,ω₂)

The effect of the Wiener filter on a blurred noisy image is to (1) pass spatial frequencies that are not attenuated by the PSF and that have a high signal-to-noise ratio; (2) amplify spatial frequencies that are attenuated by the PSF and that have a high signal-to-noise ratio; and (3) to attenuate spatial frequencies that have a low signal-to-noise ratio.

The baseline multi-frame restoration algorithm works by averaging the aligned regions of interest of consecutive video frames L₁ to L_{N} and applying a Wiener filter to the result. The frame averaging reduces additive image noise and the Wiener filter deblurs the effect of the PSF. The Wiener filter applied to a time averaged frame can reproduce the image at high spatial frequencies that were attenuated by the PSF more accurately than a Wiener filter applied to a single video frame. By reproducing the high spatial frequencies more accurately, the restored image will have higher effective resolution and greater clarity in detail. This is due to image noise at these high spatial frequencies being reduced through the averaging process. Each of N measurements corrupted by zero-mean additive Gaussian noise with a variance σ² gives an estimate of that value that has a variance of σ²/N. Averaging N registered and warped images reduces the additive noise variance and the appropriate value of K by a factor of 1/N.

In still another embodiment when n motion vectors are determined from a single motion vector of a region of interest, n deblurred regions of interest are created using n motion vectors. The deblurring for example comprises deblurring the region of interest using n variations of the motion estimation vector resulting in n number of deblurred regions of interests.

After the frame is deblurred, it is followed by blending or inserting of the restored region of interest in the frame in step 20. The restored region of interest may have one or more objects that were restored and the entire region can be re-inserted into the frame.

The deblurred regions of interest in one embodiment are blended with the frame. In one embodiment, when multiple or n number of deblurred regions of interest are created, n number of restored frames are created by blending n regions of interest with the frame. The user then selects the best-restored frame out of the n number of restored frames. Alternatively, a user may select the best-deblurred region of interest out of n deblurred regions of interest and the selected deblurred region of interest can be blended with the frame. The edges of the region of interest may be feather blended with the frame in accordance with one embodiment such that the deblurred region of interest is smoothly blended into the original image.

A blending mask can be used to combine the regions of the multi-frame reconstructions with the background region of a single observed frame, thus providing a more natural, blended result for a viewer. The blending mask M is defined in a base frame that has a value of 1 inside the region of interest and fades to zero outside of that region linearly with distance to the regions of interest. The blending mask M is used to blend a restored image I_{R} with a fill image I_{f} using:

I(r,c)=M(r,c)I_{R}(r,c)+(1−M(R,c))I_{f}(R,c).

The figures on the pages that follow identify some examples of the use of image restoration processing, such as can be performed using the techniques described herein, for the purpose of generating an image that more clearly identifies a particular aspect of interest. The figures relate to a sporting event, and in this example the region relates to whether or not a player had stepped out of bounds at an important moment during a football game.

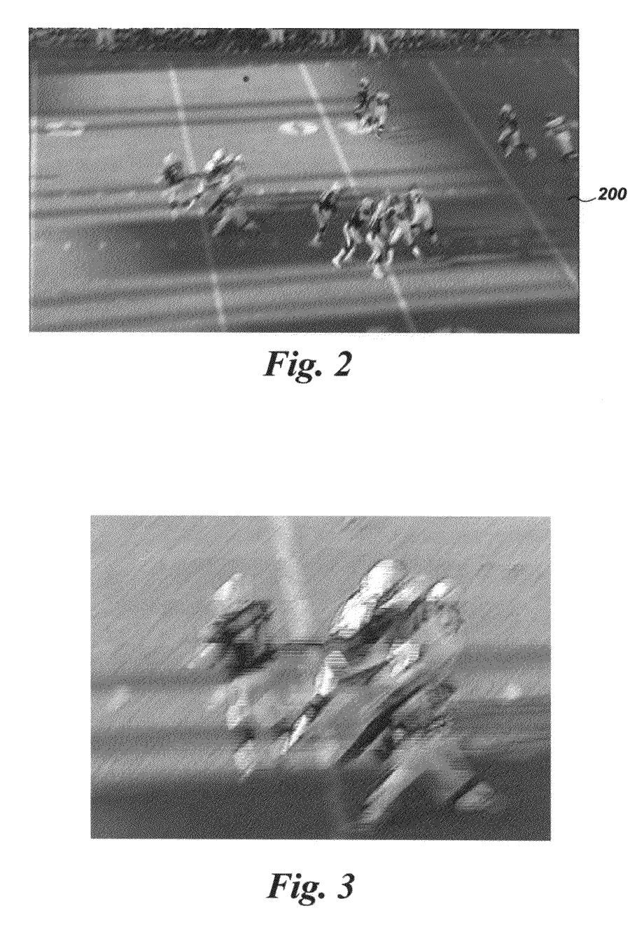

FIG. 2 shows the original image captured during a game by a video camera. This image 200 shows a portion of the playing field and the play in action with multiple players in motion.

FIG. 3 shows an interlaced frame of the image 200 that has been subject to re-sizing to obtain a better view of an area of interest. In one embodiment the operator can pan and zoom in on the particular area to obtain a better view or the area. The re-sizing is more typical in a more manual selection process.

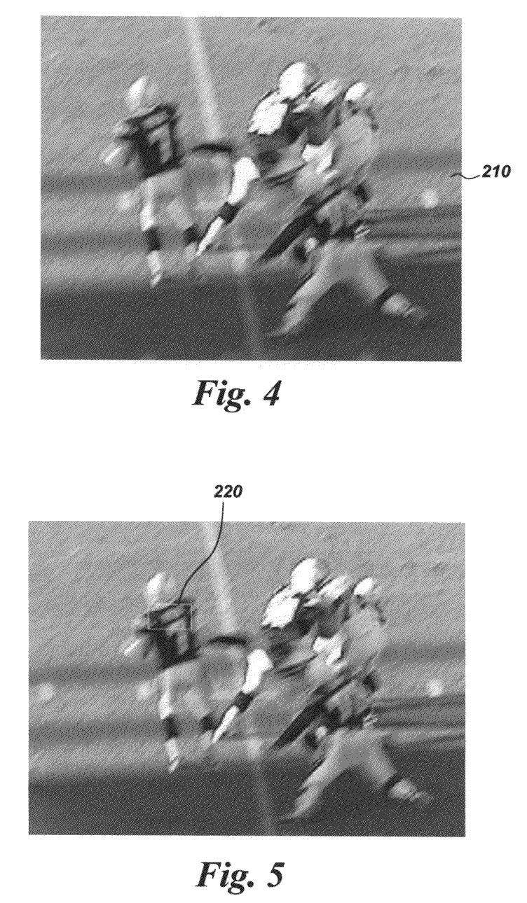

FIG. 4 shows the portion of the selected frame 200 that was re-sized 210. Typically a user is presented with the display and asked to select the region of interest.

FIG. 5 illustrates a region of interest 220 selected that in this example includes name of the player at the backside of his shirt. Here the region of interest is either manually selected or automatically selected by a computer. In one embodiment the user is asked to select the region of interest, which can be done by using a mouse and creating a box or other shaped polygon to cover the appropriate area. Alternatively, the user can select a point of interest and the program automatically selects a region of interest around the point of interest. In yet a further embodiment, the region of interest can be automatically generated using known fixed items, telemetry data or by having GPS or similar tracking devices deployed with the object that is to be the subject of enhancement.

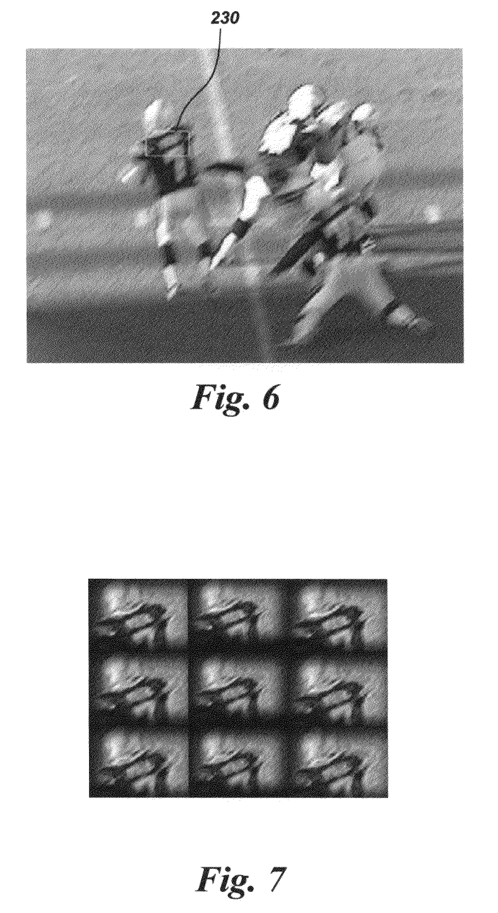

FIG. 6 shows a graphical user interface with the selected region of interest of FIG. 5 in which the user is asked to select a point of interest 230. The point of interest may be selected manually by the user. In another embodiment the program can select the center of the region of interest as a point of interest.

FIG. 7 shows different deblurred and restored regions of interest 240 selected by the user. Various steps as illustrated in the detailed description above are applied to the region of interest selected and in this embodiment it has resulted in nine different deblurred and restored regions of interest. Any one of the restored regions of interest is selected out of the nine restored regions of interest and is blended with the frame selected. The user can select the best region of interest for subsequent or the system can automatically make a selection. One automated selection is to simply select a central image.

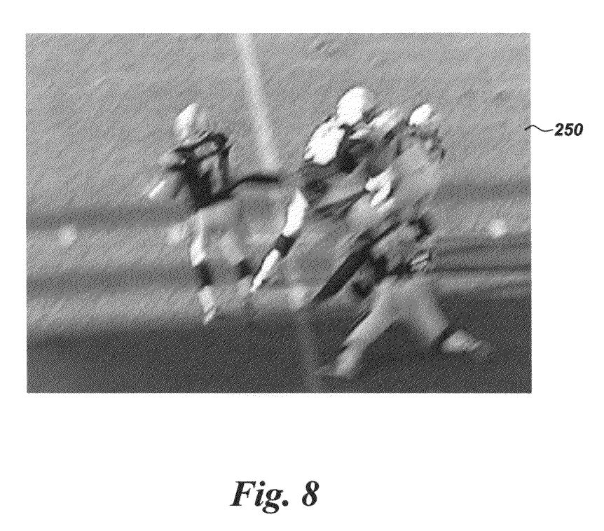

FIG. 8 shows a frame 250 with the restored region of interest blended with the frame. The blending is done in such a manner that it does showcase discontinuity close to the edge of the region of interest when blended with the frame.

FIG. 9 shows a system embodiment of an invention for restoring one or more images. The system comprise of at least one camera to capture video or images. The diagram shows two cameras 30, however, the number of cameras depend upon the utility and requirement of the user. The camera used can comprise of cameras already known in the art including camcorder and video cameras. The pictures, videos or images captured by the cameras 30 are then processed by a computing device 32 using one or more processes as described herein.

The computing device 32 is coupled to permanent or temporary storage device 34 for storing programs, applications and/or databases as required. The storage device 34 can include, for example, RAM, ROM, EPROM, and removable hard drive.

In one aspect, an operator interacts with a computing device 32 through at least one operator interface 38. The operator interface can include hardware or software depending on the configuration of the system. The operator display 40 displays a graphical user interface to perform or give one or more instructions to the computing device. The processed or restored images or intermediate images or graphical user interface are transmitted through transmissions 42 to the end users. The transmissions include wired or wireless transmissions using private network, public network etcetera. The restored images transmitted to the user are displayed on user display 44. According to one aspect, knowledge about the processing performed to produce the image, a priori information, is used to assist in the restoration.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A method of image restoration, comprising:
selecting at least one frame to be restored;
selecting at least one region of interest in the frame;
estimating motion within said region of interest;
determining blur within said region of interest;
performing deblurring of said region of interest; and
generating a restored region of interest in said frame.

2. The method of claim 1 wherein the frame is interlaced and split in two or more frames for estimating motion in said region of interest.

3. The method of claim 1 wherein the region of interest occupies substantially all of said frame.

4. The method of claim 1 wherein region of interest selection comprises one of automatic selection, semi-automatic selection or manual selection using a graphical user interface.

5. The method of claim 1 wherein the region of interest selection further comprises selecting a point of interest.

6. The method of claim 5 wherein the motion estimation is performed about the point of interest.

7. The method of claim 5 wherein the region of interest selection comprises selection of a point of interest around which the region of interest is established.

8. The method of claim 5 wherein selecting the point of interest comprises one of manual selection or automatic selection.

9. The method of claim 1 wherein the region of interest selection comprises automatic selection of a center point in said region around which motion estimation is performed.

10. The method of claim 1 wherein estimating motion comprises deinterlacing said frames and determining a pixel-to-pixel motion between said deinterlaced frames.

11. The method of claim 1, wherein the region of interest comprises at least one object in the region of interest.

12. The method of claim 11 comprising estimating motion of said object.

13. The method of claims 12 wherein the deblurring comprises deblurring said object in the region of interest.

14. The method of claim 1 wherein the motion estimation comprises determining a motion estimation vector in the region of interest.

15. The method of claim 14 wherein the motion estimation comprises determining a number of variations of the motion estimation vector.

16. The method of claims 15 wherein deblurring comprises deblurring the region of interest using said number of variations of the motion estimation vector resulting in a number of restored regions of interest.

17. The method of claim 16 wherein a user selects a best-restored region of interest out of the number of restored regions of interest.

18. The method of claim 1 wherein said blur comprises at least one of optical blur and motion blur.

19. The method of claim 1 wherein blur estimation comprises using at least one of motion estimation or domain information.

20. The method of claim 19 wherein the domain information comprises optical motion, object motion, camera motion and object of frame information.

21. The method of claim 1 wherein the deblurring is performed by using at least one of Wiener filtering, morphological filtering, wavelet denoising and linear and non linear image reconstruction with or without regularization.

22. The method of claim 1, wherein generating of the restored image in the frame further comprises blending the restored region of interest with the frame.

23. The method of claim 22 wherein the blending further comprises feather blending of the edges of contact of the restored region of interest with the frame.

24. The method of claims 22 wherein the blending comprises blending of a number of restored regions of interest with said frame resulting in a number of restored frames.

25. The method of claim 24 wherein a user selects a best-restored frame out of the number of restored frames.

26. A method for restoring at least a portion of a frame, comprising:
selecting said frame for restoration,
deinterlacing said frame to obtain at least one of a previous frame or a subsequent frame;
establishing a region of interest in said frame;
estimating at least one of an optical blur kernel and a motion blur kernel; deblurring said region of interest using at least said motion blur kernel and said optical blur kernel and creating a deblurred region; and
blending said deblurred region into said frame.

27. The method of claim 26 wherein at least one of said motion blur kernel and said optical blur kernel are derived from domain information.

28. The method of claim 26 further comprising performing motion estimation in the region of interest denoting the motion of pixels between adjacent frames.

29. The method of claim 26 wherein said establishing the region of interest is performed by a user with a graphical user interface on a computer.

30. A computer readable medium comprising computer executable instructions adapted to perform the method of claim 26.
